(19) United States
(12) Patent Application Publication
(10) Pub. No.: US 2005/0278082 A1
(43) Pub. Date: Dec. 15, 2005

(54) Systems and methods for verification and resolution of vehicular accidents

(76) Inventor: David Weekes, St. Peter (BB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/148,211

(22) Filed: Jun. 9, 2005

Related U.S. Application Data
(60) Provisional application No. 60/578,283, filed on Jun. 10, 2004.
(60) Provisional application No. 60/590,436, filed on Jul. 23, 2004.

(51) Int. Cl. G06F 19/00

(52) U.S. Cl. 701/1; 340/438

(57) ABSTRACT

Embodiments consistent with the invention provide a computer-implemented method for more accurately reporting vehicular accidents. The method comprises electronically receiving a first data from a plurality of sensors embedded within a vehicle, wherein the first data includes information regarding a location of a deformation created as a result of an accident involving the vehicle and electronically receiving a second data including information from police reports regarding the accident or from insurance claims submitted by parties involved in the accident. The method further comprises electronically comparing the first data with the second data and finding any discrepancies between the first data and second data and electronically reporting any discrepancies to an interested party.

### RELATED APPLICATIONS

This application claims the benefit of priority under 35 U.S.C. 119 to U.S. Provisional Application No. 60/578,283, filed Jun. 10, 2004, and U.S. Provisional Application No. 60/590,436, filed Jul. 23, 2004, the disclosures of which are expressly incorporated herein by reference in their entirety.

### TECHNICAL FIELD

The present invention relates generally to the reporting of vehicular accidents, and, more particularly, to systems and apparatus for the verification and resolution of vehicular accidents.

### BACKGROUND

With an increase in population comes the increased use of vehicles, such as cars, trucks, buses, trains, airplanes, etc., to travel, commute, transport goods, etc. However, the use of vehicles subjects society to many risks, one of which is vehicular accidents. Currently, the reporting of these vehicular accidents create significant risks to society. For example, there have been documented cases of fraudulent reporting of accidents by the parties involved in these accidents, cases of insurance fraud, cases of conflicting statements by the parties involved in these accidents, cases of inaccuracies or uncertainties on the cause of such accidents, etc.

In addition, especially since the terrorist attacks of Sep. 11, 2001, the increased use of vehicles increases the number of incidents involving drive-by shootings and the use of explosives that are attached to these vehicles. Existing systems fail to adequately address these risks and prevent these problems from occurring. Consequently, existing systems fail to meet the safety expectations of drivers, insurance companies, and the general public. Accordingly, there is a need for systems and methods to more accurately monitor and report the use of vehicles.

### SUMMARY

Accordingly, embodiments consistent with the present invention relate to monitoring and reporting systems and methods that may alleviate one or more of the limitations or disadvantages existing in the related art.

Embodiments consistent with the invention provide a control system for use in a vehicle. The control system comprises a matrix of conductive lines extending across at least a portion of the vehicle, a sensor for sensing a deformation of the matrix, and an indicator operable to indicate a deformation of the vehicle when the sensor senses a deformation of the matrix.

Embodiments consistent with the invention also provide a computer-implemented method for more accurately reporting vehicular accidents. The method comprises electronically receiving a first data from a plurality of sensors embedded within a vehicle, wherein the first data includes information regarding a location of a deformation created as a result of an accident involving the vehicle and electronically receiving a second data including information from police reports regarding the accident or from insurance claims submitted by parties involved in the accident. The method further comprises electronically comparing the first data with the second data and finding any discrepancies between the first data and second data and electronically reporting any discrepancies to an interested party.

Embodiments consistent with another aspect of the invention provide a computer program product including instructions for execution by a processor to perform a method for more accurately reporting vehicular accidents. The method comprises electronically receiving a first data from a plurality of sensors embedded within a vehicle, wherein the first data includes information regarding a location of a deformation created as a result of an accident involving the vehicle and electronically receiving a second data including information from police reports regarding the accident or from insurance claims submitted by parties involved in the accident. The method further comprises electronically comparing the first data with the second data and finding any discrepancies between the first data and second data and electronically reporting any discrepancies to an interested party.

Embodiments consistent with yet another aspect of the invention provide a computer system for more accurately reporting vehicular accidents. The system comprises a component for receiving a first data from a plurality of sensors embedded within a vehicle, wherein the first data includes information regarding a location of a deformation created as a result of an accident involving the vehicle and a component for receiving a second data including information from police reports regarding the accident or from insurance claims submitted by parties involved in the accident. The system further comprises a component for comparing the first data with the second data and finding any discrepancies between the first data and second data and a component for reporting any discrepancies to an interested party.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 illustrates an exemplary vehicular safety system, consistent with the principles of the present invention.

FIG. 2 is an exemplary structure of a software program for the improved management of vehicular safety, in accordance with the systems and methods consistent with the principles of the present invention.

FIG. 3 is an exemplary flowchart of a process for the improved reporting of vehicular accidents, in accordance with the systems and methods consistent with the principles of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

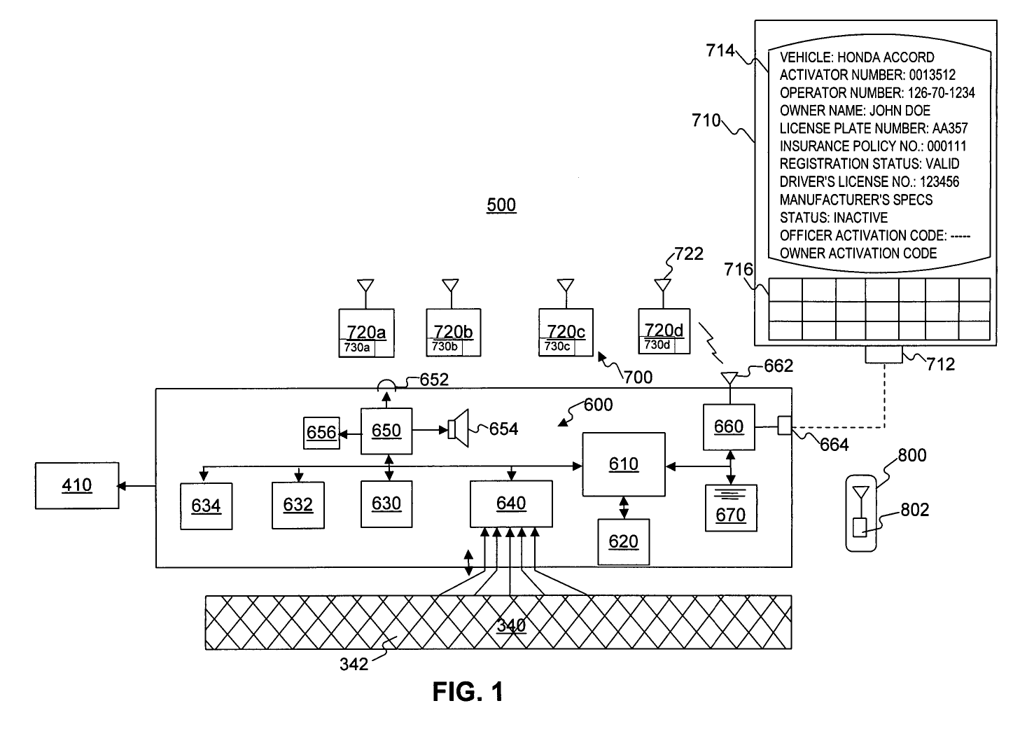

FIG. 1 illustrates an exemplary vehicular safety system 500 consistent with the present invention. As shown in FIG. 1, vehicular safety system 500 may include an accident module 600 and a monitoring network 700.

Accident module 600 may include a manager 610, a memory 620, a decal sensor 630, a license plate sensor 632, a gyro 634, a case sensor (or sensors) 640, an indicator (or indicators) 650, a network interface 660, and a power source 670. An embodiment of accident module 600 may be located on-board each vehicle monitored by vehicular safety system 500, as illustrated in FIG. 1. Accident module 600 may be located in any location within vehicle 410, such as on the dash board, in the trunk, underneath the seats, etc.

Manager 610 may manage the operation of decal sensor 630, license plate sensor 632, gyro 634, case sensor 640, indicator 650, and network interface 660. Manager 610 may be implemented using, e.g., a general purpose computer having a processor that may be selectively activated or configured by a computer program to perform one or more methods consistent with the present invention. Alternatively, manager 610 may be implemented using a specially constructed computer or other electronic circuit. Manager 610 may be coupled to a secondary manager (not shown). The secondary manager may be used as a backup to manager 160. For instance, the secondary manager can include a copy of all the data stored in memory 620.

Memory 620 may store computer programs and/or data used by manager 610. Memory 620 may also store identifying information for vehicle 410. For example, memory 620 may store a registration number, license plate number, etc., associated with vehicle 410. Memory 620 may also store a manifest identifying, for example, the owner or user of vehicle 410 (e.g., by name, address, telephone number, driver's license number, etc.), insurance information (e.g., policy number, coverage information, deductible, etc.), or specification information (e.g., a record of manufacturer's specifications (explained below)). Memory 620 may also store historical information regarding vehicle 410 and/or the owner of vehicle 410. For example, memory 620 may include information regarding prior accidents, prior deformations of vehicle 410, driving records, insurance compliance information, notifications of road tax delinquency, non-payment of motor vehicle registration fees, etc. The information may be transferred to memory 620 through network interface 660. Memory 620 may be implemented using, e.g., RAM and/or ROM memory.

Manager 610 may be adapted to detect accidents involving and/or deformations of vehicle 410 via sensor 640. Manager 610 may also be adapted to indicate accident and deformation information associated with vehicle 410 via indicator 650. Manager 610 may further be adapted to communicate with monitoring network 700 via network interface 660.

Case sensor (or sensors) 640 may be provided to detect an accident involving and/or a deformation of vehicle 410. As shown in FIG. 1, for example, case sensor 640 may be operatively linked to a sensor matrix 340 provided in vehicle 410. Matrix 340 may be formed by a mesh of conductive lines 342. Alternatively, matrix 340 may be formed by a single conductive line 342 crossed back across itself. Further, manager 610 may also be operatively linked to a decal sensor 630 and a license place sensor 632. Decal sensor 630 and a license place sensor 632 may be used to verify and authenticate corresponding information stored in memory 660. For instance, decal sensor 630 may be linked to a DMV or tax decal to verify data contained in such decals. Matrix 340 may be embedded within vehicle 410. Matrix 340 may be embedded within the body of vehicle 410, e.g., during the manufacturing of the body. Matrix 340 may also, for example, be extended across parts of the dashboard, windshield, etc.

Case sensor 640 may be configured to detect a deformation in a conductive line 342 of matrix 340. For example, case sensor 640 may detect a deformation by comparing the current specifications of conductive line 342 with the manufacturer's specifications stored in memory 620. If case sensor 640 detects a deformation in a conductive line 342 of matrix 340, then case sensor 640 may indicate a deformation of vehicle 410 to manager 610. Manager 610 may then indicate the deformation using indicator 650, store information regarding the deformation, such as the date and location, in memory 620, and/or report the deformation to monitoring network 700 via network interface 660.

In one embodiment consistent with the present invention, line 342 may comprise a light conducting fiber. Case sensor 640 may then be configured to, e.g., input light at one end of line 342 and detect deformation in line 342 by, for example, measuring the intensity of the light reflected from line 342 or measuring the time it takes for such a reflection to occur. These measurements may then be compared to the manufacturer's specifications stored in memory 620 to determine if line 342 contains a deformation. Alternatively, Case sensor 640 may be configured to input light at one end of line 342 and detect a break or cut in line 342 by sensing that the light is not received at the other end of line 342, or that the light is reflected back to the one end of line 342.

In another embodiment consistent with the present invention, line 342 may comprise an electrically conducting wire or wires. Case sensor 640 may then be configured to detect a deformation in line 342 by measuring the impedance between the ends of line 342. For instance, case sensor 640 may be configured to place a small voltage across each line 342 and to detect the impedance between the ends of line 342. Subsequently, these measurements may then be compared to the manufacturer's specifications stored in memory 620 to determine if line 342 contains a deformation. Alternatively, case sensor 640 may be configured to detect a break or cut in line 342 by sensing an open circuit between the ends of line 342. For instance, case sensor 640 may be configured to place a small voltage across each line 342 and to detect on open circuit by sensing, e.g., high impedance between the ends of line 342.

Additionally, case sensor 640 may be configured to detect road surface conditions. For example, case sensor 640 may configured to be a form of strain sensor on the tire treads of vehicle 410. Then case sensor 640 can be adapted to measure the coefficient of friction for example to determine the road surface condition. Case sensor 640 may also be configured to measure the temperature, moisture, humidity, lateral acceleration, longitudinal acceleration, speed, rpms, braking forces, direction, etc. as desired. Case sensor 640 may indicate these measurements to manager 610. Manager 610 may then indicate the measurements using indicator 650 and/or report the measurements to monitoring network 700 via network interface 660.

Gyro 634 may be configured to measure various angular movements and positions for vehicle 410. For example, gyro 634 may be configured to measure the direction of movement for vehicle 410, any longitudinal and latitudinal drift of vehicle 410, etc. Gyro 634 may indicate these measurements to manager 610. Manager 610 may then indicate the measurements using indicator 650 and/or report the measurements to monitoring network 700 via network interface 660.

Indicator (or indicators) 650 may be provided to indicate a deformation of vehicle 410. Indicator 650 may include audio and/or visual indicators. As illustrated in FIG. 1, for example, indicator 650 may include one or more indicator lights 652, an audio output indicator (such as a speaker) 654, and/or a display 656 (e.g., a liquid crystal display). If sensor 640 reports a deformation of vehicle 410, manager 610 may control indicator 650 to provide an indication of the deformation. For example, manager 610 may control speaker 654 to sound an alarm if a deformation has been indicated by sensor 640. As another example, manager 610 may control indicator lights 652 and/or display 656 to display one color (e.g., red) and/or blink if a deformation has been indicated and display another color (e.g., green) in the absence of a deformation.

Network interface 660 may be provided to allow communication between accident module 600 and monitoring network 700. Network interface 660 may comprise a wireless interface, e.g., an RF interface 662, and/or a wired interface 664. Network interface 660 may also be used to indicate a deformation of vehicle 410. For example, manager 610 may use interface 660 to report a deformation of vehicle 410 to monitoring network 700.

Interface 660 may also be used to access memory 620. For example, a manufacturer or service technician may use interface 660 to upload a new program for manager 610 and specifications information into memory 620. As another example, the insurance provider for vehicle 410 may use interface 660 to enter insurance information into memory 620. Further, interface 660 may be used by government authorities, such as the Department of Motor Vehicles, to enter or download identification information, such as vehicle registration information, vehicle license plate information, etc. Moreover, interface 660 may be used by monitors (discussed below) to request accident information including deformation information.

Communications with network interface 660 may be password protected and/or encrypted to prevent unauthorized persons from gaining control of manager 610 or accessing information in memory 620. Further, different entities may be given different passwords that allow different levels of access to manager 610 and/or memory 620. For example, insurance companies may be given a password that allows them to change insurance information in memory 620, but not to reprogram manager 610 or to change information identifying the owner of vehicle 410.

Power source 670 may be provided to supply electrical power to components 610-660. Power source 670 may comprise, e.g., a battery, such as a rechargeable lithium or NiCad battery.

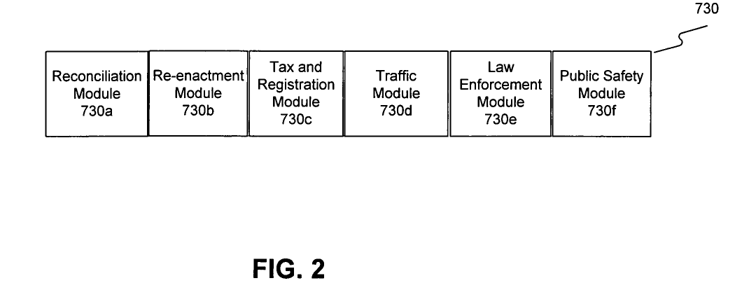

Monitoring network 700 may be configured to monitor vehicle 410 under the control of a driver. Monitoring network 700 may also be adapted to perform a variety of functions based on collected data (discussed below in FIG. 2) such as, reconcile accident information with information submitted to insurance agencies or recorded in police reports or to re-enact the scene of the accident. As shown in FIG. 1, monitoring network 700 may include one or more authenticators 710 and a plurality of monitors 720.

Authenticator 710 may be provided to communicate with accident modules 600 of vehicle 410 monitored by vehicular safety system 500. Authenticator 710 may be implemented using any appropriate general purpose or specially constructed computer that may be programmable to carry out methods consistent with the present invention. For example, authenticator 710 may be implemented using a personal computer, network computer, etc. In one embodiment, authenticator 710 may be implemented using a handheld personal digital assistant (PDA). As shown in FIG. 1, authenticator 710 may include a vehicle interface 712 that is compatible with network interface 660 of vehicle 410, a display 714, and a data entry device (e.g., a keyboard or keypad) 716.

Authenticator 710 may be used to access memory 620 of vehicle 410 via vehicle interface 712. For example, authenticator 710 may be used by owners, insurance agents, or government authorities to access manifest or historical information in memory 620. For instance, a police officer may use authenticator 710 to determine the owner of vehicle 410, the owner's drivers license number, prior driving and accident records of the owner, etc. As another example, a government authority may use authenticator 710 to verify that the driver of vehicle 410 was properly licensed, whether the owner is delinquent in road tax payments, whether the owner has properly paid vehicle registration fees, etc. When accessed using the proper password and/or decryption, the information may be displayed on display 714 and/or changed using data entry device 716.

Monitors 720 may be provided with program 730 to perform a variety of functions based on collected data. For instance, as set forth above, if sensor 640 senses a deformation of vehicle 410, manager 610 may report the deformation to monitoring network 700 by transmitting a deformation signal identifying vehicle 410 and indicating the vehicle 410 has a deformation from being in an accident. Alternatively, monitoring network may request accident information including deformation information as needed. Authenticator 710 may also be provided with program 730 (not shown).

Monitors 720 may include a wireless interface 722 compatible with network interface 660 of vehicle 410. Monitors 720 may send signals to and receive signals from vehicle 410 via wireless interface 722. Monitors 720 may be located at any locations controlled by parties that may be interested in information provided by vehicular safety system 500. For instance, monitors 720 may be located at the offices of insurance companies, offices of government authorities, homes of private citizens, etc.

Program 730, consistent with the present invention, may include components, such as modules to implement methods consistent with embodiments of the present invention. Program 730, as shown in FIG. 2, may include one or more of a reconciliation module 730a, a re-enactment module 730b, a tax and registration module 730c, a traffic module 730d, a law enforcement module 730e, and a public safety module 730f.

Reconciliation module 730a, by way of example, can be used to reconcile the data received from vehicle 410 with information contained in police reports and insurance claims and to find any discrepancies. For example, after obtaining data regarding the location of a deformation resulting from an accident involving vehicle 410, reconciliation module 730a may compare the data with accident reports submitted by police officers and/or insurance claims submitted by the parties involved in the accident. This comparison would allow the reconciliation and detection of discrepancies, resulting in more accurate reporting of the accident and damage caused by the accident. Additionally, this would allow insurance companies to verify the accuracy of submitted insurance claims to prevent for example insurance fraud. Furthermore, reconciliation module 730a may be used to access the information stored in memory 620 to obtain information such as insurance information and/or vehicle identification information to ensure for example that vehicle 410 is properly covered.

Re-enactment module 730b, by way of example, may be used to re-enact an accident involving vehicle 410. To this end, an automated motorized robot (“AMR”) and a perimeter defining unit (“PDU”), also an automated motorized robot, may be provided to navigate a road where accident occurred and to take measurements that would enable accurate re-enactment of the accident. The AMR may include an embedded compass and a directional recorder and the PDU may also include a directional unit and recorder. Additionally, stationary culvert definers may be provided to define the boundary of a sewer or drain along the road.

At the time of an accident involving vehicle 410, a police officer at the scene of the accident may place the AMR and PDU at the beginning center-line waypoint of an intersection of the road where the accident occurred. The AMR may be placed at the center of the intersection while the PDU may be placed on the side of the intersection. The officer may also place RFID tags on the center-line waypoints along the road of the accident. Subsequently, the AMR and PDU may navigate along the road in synchronization using the center-line waypoints for guidance. To ensure proper alignment between the AMR and PDU prior to the start of navigation, laser beams may be used between the AMR and PDU. As the AMR and PDU navigate along the road, measurements of various conditions may be taken that may be later used to properly re-enact the accident. Table 1 shows an exemplary list of conditions that may be measured and the elements that can be used for obtaining the measurement. For example, the AMR communicating with a PDU located on both sides of the road, by, for example, using radio frequency communication, can determine the distance from the AMR to each PDU and calculate the width of the road. The distance to each PDU can be calculated using any conventional technique. For example, the distance can be determined by measuring the time light transmitted from the AMR takes to arrive at each PDU or the time it takes for the light to be reflected by each PDU and return to the AMR.

TABLE 1
Measurements

| Condition | Element |
|---|---|
| Direction | AMR, PDU, or pre-defined by the RFID |
| | tags |
| Length and Width of Road | AMR and PDU |
| Road Slope | AMR |
| Skid Mark Locations | RFID tags |
| Debris Locations | Stationary Culvert Definers |
| Waypoint Retrieval | RFID tags |

After completing navigation of the road, the collected data may then be transmitted to monitoring network 700. Subsequently, re-enactment module 730b may use conventional pattern recognition techniques to determine the conditions and events that led to the accident involving vehicle 410. For example, re-enactment module 730b, based on data regarding the slope of the road and the location of skid marks on the road along with the deformation, road surface conditions, speed, and rpms data received from all vehicles involved in the accident, may determine that one vehicle involved in the accident rear-ended another vehicle in the accident. Re-enactment module 730b may then create a graphic display showing the re-enactment of the accident. The graphic display can show the road of the accident using the length and width of the road as a reference and then may visually display the vehicles involved in the accident and the events that led to the accident.

Tax and registration module 730c, by way of example, can be used to ensure proper registration of vehicles and payment of road taxes. For example, RFID tags may be embedded in the vehicle's license plate. RFID readers may be provided at fixed locations, such as at tollbooths and along roadsides or as portable readers carried by surveillance vehicles and handheld devices. The RFID readers then can identify any vehicle accurately when needed. For example, if vehicle 410 went through a tollbooth without paying the appropriate toll, RFID readers located near the tollbooth could read the RFID tag located in the license plate of vehicle 410 and transmit the identification information to monitoring network 700. Subsequently, tax and registration module 730c could match the identification information with corresponding vehicle data such as, vehicle registration number, owner details, make of vehicle, model of vehicle, color of vehicle, insurance information, etc. This matching would allow the identification of the fraudulent owner and an appropriate response could taken.

In another example, government officials may request, via monitors 720, registration status of vehicle 410. Government officials may then detect, for instance, the non-payment of motor vehicle registration fees by the owner of vehicle 410

Traffic module 730d, by way of example, can be used to provide statistics and charts regarding traffic and thereby provide mechanism for controlling and managing traffic. For example, as vehicle 410 travels, certain conditions related to traffic could be measured by manager 610 of vehicle 410, logged and transferred to monitoring network 700 and the results could be graphically displayed. Collection of this data from a plurality of vehicles may be charted to show for example, how traffic conditions changed over time, the distances traveled by vehicles, the location of vehicles during travel, traffic speeds, areas of congestion, braking activity, relative vehicle spacing over a period of time, etc. Each vehicle can measure and log the needed measurements by configuring case sensor 640 to measure speed, location, distance traveled, use of breaks, etc.

Law enforcement module 730e, by way of example, can be used to provide mechanisms for performing a variety of law enforcement functions. For example, law enforcement module 730e may be used to detect the theft of a vehicle. For example, in one embodiment, an RFID tag can be embedded in the license plate of vehicle 410. At the time of a theft of vehicle 410, RFID readers, located at fixed locations, can obtain identification information regarding vehicle 410 from the embedded RFID tag and transmit this information to monitoring network 700. Subsequently, law enforcement officials using monitoring network 700 can, based on the received identification information, communicate with manager 610 of vehicle 410 to determine for example the location of vehicle 410 after its theft and enable law enforcement officials to send forces to the identified location.

Alternatively, police officers, after receiving notification of the theft of vehicle 410 by for example a phone call, may initiate communication with manager 610 of the vehicle that was stolen. Subsequently, law enforcement can determine for example the location of vehicle 410 after its theft and enable law enforcement officials to send forces to the identified location.

In another embodiment, law enforcement module 730e may also be used for speed monitoring and other remote surveillance applications. For example, as discussed above, RFID tags may be embedded within the license plate of vehicle 410. Subsequently, for example, if a radar detector is used to detect a speeding violation by vehicle 410, an RFID reader may also be use to obtain identification information and enable the gathering of more detailed identification information by users of monitoring network 700. Further, monitoring network 700 may also request manager 610 of vehicle 410 to provide data regarding the speed of vehicle 410. This would provide the user with an additional verification and proof of the speeding violation. Alternatively, law enforcement officials may select a random group of vehicles and request manager 610 of each vehicle to provide data regarding the speed of vehicle 610 during designated periods of time and find any speed violations.

Law enforcement module 730e can also be used to detect illegal parking. Similar to the above, RFID readers can be used to obtain identification information from RFID tags embedded within the license plate of vehicle 410 and transmit the information to monitoring network 700. Also similarly, more detailed information regarding the owner of vehicle 410 may be obtained and an appropriate responsive action to the parking violation may be taken. Alternatively, law enforcement officials, after finding that vehicle 410 has been illegally parked, may initiate communication with manager 610 to obtain any desired information, such as the name and telephone number of the owner.

Public safety module 730f, by way of example, can be used to provide support for the detection and prevention of threats to public safety created by use of vehicles. For instance, public safety module 730f can be used to provide support for drive-by shootings, robberies, and hit and run incidents. Similar to the above, RFID readers may be used to determine the identification of a vehicle involved in a drive-by shooting, in a robbery, and/or a hit and run accident. For example, if vehicle 410 was involved in a drive-by shooting, RFID readers located near the scene of the shooting could log the identity of all vehicles in the vicinity of the shooting and provide such information to monitoring network 700. Users of monitoring network 700 may then match the identification information of the identified vehicles with other information such as the identity of the owners of the vehicles and thereby obtain a list of potential owners who may be involved in the shooting.

Alternatively, law enforcement officials, after receiving a notification of the shooting, may immediately be able to begin communicating with manager 610 of all vehicles in the vicinity of the shooting. Law enforcement officials may request manager 610 of the vehicles to provide, for example, data regarding the location of the vehicle during the shooting, the path of the vehicle taken over a certain period of time, and/or the current location of the vehicle. Law enforcement officials then may respond accordingly.

As another example, if vehicle 410 was involved a hit and run accident, RFID readers located near the scene of the accident could log the identity of all vehicles in the vicinity of the accident and provide such information to monitoring network 700. Users of monitoring network 700 may then match the identification information of the identified vehicles with other information such as the identity of the owners of the vehicles and thereby obtain a list of potential owners who may be involved in the accident.

Alternatively, manager 610 of vehicle 410 can provide data regarding vehicle 410 after a deformation in vehicle 410 is found. Subsequently, after law enforcement officials receive a notification of the accident, they may immediately be able to begin communicating with manager 610 based on the data received from vehicle 410. For instance, law enforcement officials may analyze the data received from vehicle 410 to determine the location of vehicle 410 at the time of the accident, the location of a deformation in vehicle 410, the current location of vehicle 410, etc. Law enforcement officials then may respond accordingly.

Public safety module 730f can also be used to detect the storage of illegal objects, such as drugs and guns in secret compartments located in vehicle 410. Similarly, public safety module 730f can also be used to detect explosive attachments, such as bombs in vehicle 410. For example, case sensor 640 may be configured to measure strain and weight of objects in vehicle 410. For instance, case sensor 640 may be configured to, e.g., transmit a radio frequency pulse and detect a strain by measuring the time, resonant frequency, amplitude, and/or phase of the reflected wave. These measurements may then be used to identify the object causing the strain by using, for example, conventional pattern recognition techniques such as neural networks or fuzzy logic. This identification information may then be transmitted to monitoring network 700 for an appropriate response.

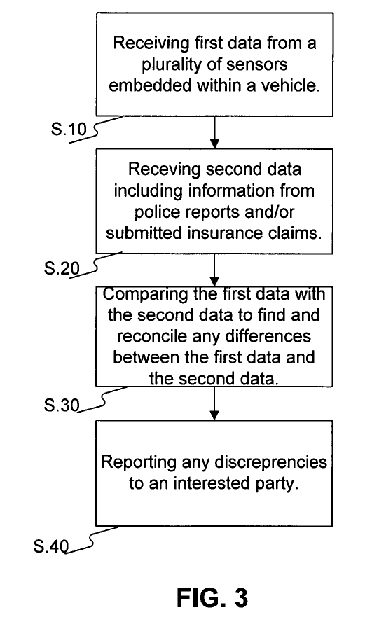

FIG. 3 is an exemplary flowchart of a method for more accurately reporting vehicular accidents. Although the steps of the flowchart are described in a particular order, one skilled in the art will appreciate that these steps may be performed in a modified or different order. Further, one or more of the steps in FIG. 3 may be performed concurrently or in parallel.

First, data regarding a deformation of vehicle 410 is electronically received, wherein the data is obtained from a plurality of sensors embedded within vehicle 410 (step S.10). The data may also include any data regarding the vehicle as discussed above, such as, road surface conditions, temperature, humidity, moisture, speed, location of an object in the vehicle, acceleration of the vehicle, drift of the vehicle, rpms, braking forces, etc.

After receiving the data from vehicle 410, data from submitted police reports and/or insurance claims from parties involved in the accident are electronically received (step S.20). Then a comparison is made between the data received from vehicle 410 and the data contained in submitted police reports and/or insurance claims to reconcile any differences and to determine if there are any discrepancies (step S.30). For instance, if submitted insurance claims indicate that there was body damage to vehicle 410 that was not indicated by the data received from vehicle 410, then this discrepancy would be found. Finally, any discrepancies that are found may be electronically reported to an interested party (step S.40). For example, a discrepancy as to the body damage may be reported to insurance companies to prevent insurance fraud.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. In a vehicle, a control system comprising:
a matrix of conductive lines extending across at least a portion of the vehicle;
a sensor for sensing a deformation of the matrix; and
an indicator operable to indicate a deformation of the vehicle when the sensor senses a deformation of the matrix.

2. The control system of claim 1, wherein the matrix comprises conductive lines contained within the vehicle.

3. The control system of claim 2, wherein the conductive lines comprise electrically conductive lines.

4. The control system of claim 2, wherein the conductive lines comprise light conductive lines.

5. The control system of claim 2, wherein the sensor senses a deformation of the matrix by sensing an open circuit between the ends of one of the conductive lines.

6. The control system of claim 1, wherein the indicator comprises at least one of a visual indicator or an audio indicator.

7. The control system of claim 1, wherein the indicator comprises a signal transmitted to a monitoring network.

8. A computer-implemented method for more accurately reporting vehicular accidents comprising:
electronically receiving a first data from a plurality of sensors embedded within a vehicle, wherein the first data includes information regarding a location of a deformation created as a result of an accident involving the vehicle;
electronically receiving a second data including information from police reports regarding the accident or from insurance claims submitted by parties involved in the accident;
electronically comparing the first data with the second data and finding any discrepancies between the first data and second data; and
electronically reporting any discrepancies to an interested party;

9. The method of claim 8 further comprising:
electronically receiving a third data from an automated robot regarding conditions of a road where the accident occurred.

10. The method of claim 9, wherein the third data is used in combination with the first data and the second data to create a re-enactment of the accident and the re-enactment is displayed to the interested party.

11. The method of claim 9, wherein the third data includes at least one of a width of the road, a length of the road, a slope of the road, a location of skid marks on the road, or a location of debris on the road.

12. The method of claim 8, wherein the first data further includes at least one of a direction of movement of the vehicle, a longitudinal drift of the vehicle, or a latitudinal drift of the vehicle.

13. The method of claim 12, wherein the first data is used to provide support for resolution of a drive-by shooting or a hit and run accident.

14. A computer program product including instructions for execution by a processor to perform a method for more accurately reporting vehicular accidents, the method comprising:
electronically receiving a first data from a plurality of sensors embedded within a vehicle, wherein the first data includes information regarding a location of a deformation created as a result of an accident involving the vehicle;
electronically receiving a second data including information from police reports regarding the accident or from insurance claims submitted by parties involved in the accident;
electronically comparing the first data with the second data and finding any discrepancies between the first data and second data; and
electronically reporting any discrepancies to an interested party;

15. The method of claim 14 further comprising:
electronically receiving a third data from an automated robot regarding conditions of a road where the accident occurred.

16. The method of claim 15, wherein the third data is used in combination with the first data and the second data to create a re-enactment of the accident and the re-enactment is displayed to the interested party.

17. The method of claim 15, wherein the third data includes at least one of a width of the road, a length of the road, a slope of the road, a location of skid marks on the road, or a location of debris on the road.

18. The method of claim 14, wherein the first data further includes at least one of a direction of movement of the vehicle, a longitudinal drift of the vehicle, or a latitudinal drift of the vehicle.

19. The method of claim 18, wherein the first data is used to provide support for resolution of a drive-by shooting or a hit and run accident.

20. A system for more accurately reporting vehicular accidents, the system comprising:
a component for receiving a first data from a plurality of sensors embedded within a vehicle, wherein the first data includes information regarding a location of a deformation created as a result of an accident involving the vehicle;
a component for receiving a second data including information from police reports regarding the accident or from insurance claims submitted by parties involved in the accident;
a component for comparing the first data with the second data and finding any discrepancies between the first data and second data; and
a component for reporting any discrepancies to an interested party.

21. The system of claim 20 further comprising:
a component for receiving a third data from an automated robot regarding conditions of a road where the accident occurred.

22. The system of claim 21, wherein the third data is used in combination with the first data and the second data to create a re-enactment of the accident and the re-enactment is displayed to the interested party.

23. The system of claim 21, wherein the third data includes at least one of a width of the road, a length of the road, a slope of the road, a location of skid marks on the road, or a location of debris on the road.

24. The system of claim 20, wherein the first data further includes at least one of a direction of movement of the vehicle, a longitudinal drift of the vehicle, or a latitudinal drift of the vehicle.

25. The system of claim 24, wherein the first data is used to provide support for resolution of a drive-by shooting or a hit and run accident.
